(19) United States
(12) Patent Application Publication
(10) Pub. No.: US 2021/0397830 A1
(43) Pub. Date: Dec. 23, 2021

(54) FORM RECOGNITION METHODS, FORM EXTRACTION METHODS AND APPARATUSES THEREOF

(71) Applicant: Beijing Sensetime Technology Development Co., Ltd., Beijing (CN)

(72) Inventors: Mingjie ZHAN, Beijing (CN); Xuebo LIU, Beijing (CN); Ding LIANG, Beijing (CN)

(21) Appl. No.: 17/463,685

(22) Filed: Sep. 1, 2021

Related U.S. Application Data
(63) Continuation of application No. PCT/CN2019/113015, filed on Oct. 24, 2019.

(30) Foreign Application Priority Data
Sep. 30, 2019 (CN) 201910944101.7

(51) Int. Cl. G06K 9/00; G06K 9/34; G06K 9/46

(52) U.S. Cl. CPC G06K 9/00449; G06K 9/344; G06K 2209/01; G06K 9/4609; G06K 9/00483

(57) ABSTRACT

Methods, devices, apparatuses, and systems for form recognition and form extraction are provided. In one aspect, a form recognition method includes: obtaining a form line extraction result of a to-be-recognized form image by performing a form line extraction process on the to-be-recognized form image, obtaining a corrected to-be-recognized form image by performing a correction process on the to-be-recognized form image based on the form line extraction result of the to-be-recognized form image and a preset form template, and performing a text recognition process on the corrected to-be-recognized form image to obtain a form recognition result. The form line extraction result includes at least one of a plurality of first form lines or a plurality of first form line intersections, and the preset form template has at least one of a plurality of preset second form lines or a plurality of preset second form line intersections.

### CROSS REFERENCE TO RELATED APPLICATIONS

The present application is a continuation of International Application Serial No. PCT/CN2019/113015 filed on Oct. 24, 2019. International Application Serial No. PCT/CN2019/113015 claims priority to Chinese Patent Application No. 201910944101.7 filed on Sep. 30, 2019. The entire contents of each of the referenced applications are incorporated herein by reference for all purposes.

### TECHNICAL FIELD

The present disclosure relates to computer vision technology, and more particularly to a form recognition method, a form extraction method and apparatuses thereof.

### BACKGROUND

At present, OCR (Optical Character Recognition) technology is generally used to recognize scanned images of text data. Using this technology can recognize most of text characters, but cannot recognize a form image properly because the form image is often garbled during the recognition.

### SUMMARY

Embodiments of the present disclosure provide a form recognition solution and a form extraction solution.

In a first aspect, there is provided a form recognition method, including: performing a form line extraction process on a to-be-recognized form image to obtain a form line extraction result of the to-be-recognized form image, wherein the form line extraction result includes a plurality of first form lines and/or a plurality of first form line intersections; performing a correction process on the to-be-recognized form image based on the form line extraction result of the to-be-recognized form image and a preset form template, wherein the preset form template has a plurality of preset second form lines and/or a plurality of preset second form line intersections; and performing a text recognition process on the corrected to-be-recognized form image, to obtain a form recognition result.

In combination with any implementation provided by the present disclosure, performing a correction process on the to-be-recognized form image based on the form line extraction result of the to-be-recognized form image and a preset form template includes: performing a matching process on the plurality of first form lines and the plurality of second form lines to obtain a matching result of the form lines, and/or performing a matching process on the plurality of first form line intersections and the plurality of second form line intersections, to obtain a matching result of the form line intersections; and performing a correction process on the to-be-recognized form image based on the matching result of the form lines and/or the matching result of the form line intersections.

In combination with any implementation provided by the present disclosure, performing a correction process on the to-be-recognized form image based on the matching result of the form lines and/or the matching result of the form line intersections includes: obtaining a transformation parameter between the to-be-recognized form image and the preset form template based on the matching result of the form lines and/or the matching result of the form line intersections, wherein the matching result of the form lines includes the matching result of a plurality of form line pairs of the plurality of first form lines and the plurality of second form lines, and the matching result of the form line intersections includes the matching result of a plurality of form line intersection pairs of the plurality of first form line intersections and the plurality of second form line intersections; and performing a correction process on the to-be-recognized form image according to the transformation parameter.

In combination with any implementation provided by the present disclosure, obtaining a transformation parameter between the to-be-recognized form image and the preset form template based on the matching result of the form lines and/or the matching result of the form line intersections includes: obtaining a transformation parameter between the to-be-recognized form image and the preset form template based on matched form line pairs in the plurality of form line pairs, and/or based on matched form line intersection pairs in the plurality of form line intersection pairs.

In combination with any implementation provided by the present disclosure, the matching result of the form lines includes matching confidence levels of the plurality of form line pairs, and the matching result of the form line intersections includes matching confidence levels of the plurality of form line intersection pairs, obtaining a transformation parameter between the to-be-recognized form image and the preset form template based on the matching result of the form lines and/or the matching result of the form line intersections includes: obtaining the transformation parameter based on the form line pairs with a matching confidence level higher than a first preset value among the plurality of form line pairs, and/or based on the form line intersection pairs with a matching confidence level higher than a second preset value among the plurality of form line intersection pairs.

In combination with any implementation provided by the present disclosure, obtaining a transformation parameter between the to-be-recognized form image and the preset form template based on the matching result of the form lines and/or the matching result of the form line intersections includes: determining a target area based on the matching result of the form lines and/or the matching result of the form line intersections, wherein the matching result of the form lines and/or the form line intersections in the target area satisfies a preset condition; and obtaining a transformation parameter between the to-be-recognized form image and the preset form template based on the matching result of the form lines and/or the matching result of the form line intersections in the target area.

In combination with any implementation provided by the present disclosure, the preset condition includes any one or more: a number of matching form line pairs and/or matching form line intersection pairs in the target area satisfies a first condition; and a matching confidence level corresponding to matching form line pairs and/or matching form line intersection pairs in the target area satisfies a second condition.

In combination with any implementation provided by the present disclosure, the preset form template includes at least two template areas, obtaining a transformation parameter between the to-be-recognized form image and the preset form template based on the matching result of the form lines and/or the matching result of the form line intersections includes: obtaining the transformation parameter corresponding to each of the at least two template areas based on the matching result of the form lines and/or the matching result of the form line intersections; and performing a correction process on the to-be-recognized form image according to the transformation parameter includes: according to the transformation parameter corresponding to each of the at least two template areas, performing a correction process on an area of the to-be-recognized form image corresponding to each of the at least two template areas.

In combination with any implementation provided by the present disclosure, performing a correction process on the to-be-recognized form image based on the form line extraction result of the to-be-recognized form image and a preset form template includes: in response to a ratio of matching form line pairs in the plurality of first form lines reaching a first ratio value, and/or in response to a ratio of matching form line intersection pairs in the plurality of first form line intersections reaching a second ratio value, performing a correction process on the to-be-recognized form image based on the form line extraction result of the to-be-recognized form image and the preset form template.

In combination with any implementation provided by the present disclosure, performing a text recognition process on the corrected to-be-recognized form image, to obtain a form recognition result includes: performing text detection on the corrected form image to obtain a plurality of text detection boxes of the to-be-recognized form image; performing text recognition on the plurality of text detection boxes to obtain a text recognition result; and obtaining the form recognition result based on an intersection-over-union ratio between the plurality of text detection boxes and a plurality of form boxes defined by the plurality of first form lines.

In combination with any implementation provided by the present disclosure, performing a text recognition process on the corrected to-be-recognized form image, to obtain a form recognition result includes: determining at least one to-be-detected target form box from a plurality of form boxes defined by the plurality of first form lines in the to-be-recognized form image based on the preset form template; performing text recognition on the at least one target form box, to obtain a text recognition result of each target form box in the at least one target form box; and obtaining the form recognition result based on the text recognition result of the at least one target form box.

In combination with any implementation provided by the present disclosure, determining at least one to-be-detected target form box from a plurality of form boxes defined by the plurality of first form lines in the to-be-recognized form image based on the preset form template includes: receiving a recognition condition entered by a user; and determining at least one target form box from a plurality of form boxes of the preset form template based on the recognition condition.

In combination with any implementation provided by the present disclosure, the method further includes: setting an attribute for the target form box; obtaining the form recognition result based on the text recognition result of the at least one target form box includes: obtaining the form recognition result based on the attribute of the target form box and the text recognition result of the target form box.

In combination with any implementation provided by the present disclosure, the method further includes: performing a form line extraction process on a reference form image to obtain a form line extraction result of the reference form image; and performing a correction process on the form line extraction result of the reference form image to obtain the preset form template based on user input.

In a second aspect, there is provided a form recognition method, including: performing a form line extraction process on a reference form image to obtain a form line extraction result of the reference form image; generating a form template based on the form line extraction result, wherein the form template includes a plurality of second form lines and/or a plurality of second form line intersections; and performing a text recognition process on a to-be-recognized form image to obtain the form recognition result based on the form template.

In combination with any implementation provided by the present disclosure, generating a form template based on the form line extraction result includes: displaying the form line extraction result; and generating a form template based on the form line extraction result in response to receiving confirmation instruction from a user.

In combination with any implementation provided by the present disclosure, generating a form template based on the form line extraction result includes: performing an adjustment process on the form line extraction result to obtain an adjustment result in response to receiving an adjustment instruction from a user; and generating the form template based on the adjustment result.

In combination with any implementation provided by the present disclosure, the method further includes: receiving a recognition instruction from a user, wherein the recognition instruction is used to indicate a target form entry in the form template that needs to be recognized; and performing a text recognition process on a to-be-recognized form image to obtain the form recognition result based on the form template includes: performing a text recognition process on the target form entry in the to-be-recognized form image based on the form template, to obtain a form recognition result.

In combination with any implementation provided by the present disclosure, performing a text recognition process on a to-be-recognized form image to obtain the form recognition result based on the form template includes: performing a form line extraction process on the to-be-recognized form image to obtain a form line extraction result of the to-be-recognized form image, wherein the form line extraction result includes a plurality of first form lines and/or a plurality of first form line intersections; obtaining a transformation parameter based on a plurality of second form lines and/or a plurality of second form line intersections included in the form template, and the form line extraction result of the to-be-recognized form image; and performing a text recognition process on the to-be-recognized form image to obtain a form recognition result according to the transformation parameter.

In combination with any implementation provided by the present disclosure, obtaining a transformation parameter based on a plurality of second form lines and/or a plurality of second form line intersections included in the form template, and the form line extraction result of the to-be-recognized form image, includes: performing a matching process on the plurality of first form lines and the plurality of second form lines to obtain a matching result of the form lines, and/or performing a matching process on the plurality of first form line intersections and the plurality of second form line intersections, to obtain a matching result of the form line intersections; and obtaining a transformation parameter between the to-be-recognized form image and the form template based on the matching result of the form lines and/or the matching result of the form line intersections, wherein the matching result of the form lines includes the matching result of a plurality of form line pairs of the plurality of first form lines and the plurality of second form lines, and the matching result of the form line intersections includes the matching result of a plurality of form line intersection pairs of the plurality of first form line intersections and the plurality of second form line intersections.

In combination with any implementation provided by the present disclosure, obtaining a transformation parameter between the to-be-recognized form image and the form template based on the matching result of the form lines and/or the matching result of the form line intersections includes: determining a target area based on the matching result of the form lines and/or the matching result of the form line intersections, wherein the matching result of the form lines and/or the form line intersections in the target area satisfies a preset condition; and obtaining a transformation parameter between the to-be-recognized form image and the form template based on the matching result of the form lines and/or the matching result of the form line intersections in the target area.

In combination with any implementation provided by the present disclosure, the preset condition includes any one or more: a number of matching form line pairs and/or matching form line intersection pairs in the target area satisfies a first condition; and a matching confidence level corresponding to matching form line pairs and/or matching form line intersection pairs in the target area satisfies a second condition.

In combination with any implementation provided by the present disclosure, performing a text recognition process on the to-be-recognized form image to obtain a form recognition result according to the transformation parameter includes: performing a correction process on the to-be-recognized form image according to the transformation parameter; and performing a text recognition process on the corrected to-be-recognized form image, to obtain a form recognition result.

In a third aspect, there is provided a form extraction method, including: determining a plurality of directional single-connected chains in a to-be-recognized form image; performing a first merging process on at least two directional single-connected chains that satisfy a merging condition among the plurality of directional single-connected chains, to obtain a plurality of first merged line segments; performing an (i+1)-th merging process on at least two i-th merged line segments that satisfy the merging condition among a plurality of i-th merged line segments, to obtain at least one (i+1)-th merged line segment; and obtaining a form line extraction result of the form image based on the merging result of N times of merging process, where i and N are integers, and i is greater than 1 and less than N.

In combination with any implementation provided by the present disclosure, the method further includes: extending at least one end of the i-th merged line segment with at least one pixel to obtain an extended line segment of the i-th merged line segment; determining at least two i-th merged line segments that satisfy the merging condition from the plurality of i-th merged line segments based on the extended line segment of each i-th merged line segment in the plurality of i-th merged line segments.

In combination with any implementation provided by the present disclosure, the merging condition includes any one or more of: a minimum distance between end points of two to-be-merged objects is less than a first threshold; a first maximum distance between the end points of the two to-be-merged objects is less than a second threshold; and a second maximum distance from the end points of the two to-be-merged objects to a connection line corresponding to the first maximum distance between the end points of the two to-be-merged objects is less than the second threshold; wherein the to-be-merged object is a directional single-connected chain or an i-th merged line segment.

In a fourth aspect, there is provided a form recognition apparatus, including: a processing unit configured to perform a form line extraction process on a to-be-recognized form image to obtain a form line extraction result of the to-be-recognized form image, wherein the form line extraction result includes a plurality of first form lines and/or a plurality of first form line intersections; a correction unit configured to perform a correction process on the to-be-recognized form image based on the form line extraction result of the to-be-recognized form image and a preset form template, wherein the preset form template has a plurality of preset second form lines and/or a plurality of preset second form line intersections; and a recognition unit configured to perform a text recognition process on the corrected to-be-recognized form image, to obtain a form recognition result.

In a fifth aspect, there is provided a form recognition apparatus, including: an extraction unit configured to perform a form line extraction process on a reference form image to obtain a form line extraction result of the reference form image; a generation unit configured to generate a form template based on the form line extraction result, wherein the form template includes a plurality of second form lines and/or a plurality of second form line intersections; and a recognition unit configured to perform a text recognition process on a to-be-recognized form image to obtain the form recognition result based on the form template.

In a sixth aspect, there is provided a form extraction apparatus, including: a determination unit configured to determine a plurality of directional single-connected chains in a to-be-recognized form image; a first merging unit configured to perform a first merging process on at least two directional single-connected chains that satisfy a merging condition among the plurality of directional single-connected chains, to obtain a plurality of first merged line segments; a second merging unit configured to perform an (i+1)-th merging process on at least two i-th merged line segments that satisfy the merging condition among a plurality of i-th merged line segments, to obtain at least one (i+1)-th merged line segment; and an obtaining unit configured to obtain a form line extraction result of the form image based on the merging result of N times of merging process, where i and N are integers, and i is greater than 1 and less than N.

In a seventh aspect, there is provided a form recognition device, including a memory and a processor, wherein the memory is configured to store computer instructions executable by the processor, and when the computer instructions are executed, the processor is configured to implement the form recognition method according to any implementation provided by the present disclosure.

In an eighth aspect, there is provided a form extraction device, including a memory and a processor, wherein the memory is configured to store computer instructions executable by the processor, and when the computer instructions are executed, the processor is configured to implement the form extraction method according to any implementation provided by the present disclosure.

In a ninth aspect, there is provided a computer-readable storage medium with a computer program stored thereon, wherein the program is executed by a processor to implement the form recognition method according to any implementation provided by the present disclosure.

In a tenth aspect, there is provided a computer-readable storage medium with a computer program stored thereon, wherein the program is executed by a processor to implement the form extraction method according to any implementation provided by the present disclosure.

In the form recognition solution according to one or more embodiments of the present disclosure, the to-be-recognized form image is corrected based on the form line extraction result of the form image and the preset form template, and the corrected image is subjected to the text recognition process to obtain the form recognition result. Using the preset form template, the recognition of any corresponding form can be realized, and the recognition speed is fast; by correcting the to-be-recognized form image using the preset form template, the accuracy and robustness of the form recognition can be improved.

It is to be understood that the above general descriptions and the below detailed descriptions are merely exemplary and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a flowchart illustrating a form recognition method according to an embodiment of the present disclosure.

FIG. 2A shows an exemplary form extraction result of a to-be-recognized form image.

FIG. 2B shows a preset form template corresponding to FIG. 2A.

FIG. 3 shows a schematic diagram of modifying a preset form template.

FIG. 4 is a flowchart illustrating another form recognition method according to an embodiment of the present disclosure.

FIG. 5 shows an exemplary form template.

FIG. 6 is a flowchart illustrating a form extraction method according to an embodiment of the present disclosure.

FIG. 7 shows a schematic diagram of an exemplary directional single-connected chain.

FIG. 8A shows a schematic diagram of an exemplary extraction result of a directional single-connected chain.

FIG. 8B shows a schematic diagram of merging the directional single-connected chains in FIG. 8A.

FIG. 8C shows a schematic diagram of merging the line segments in FIG. 8B.

FIG. 9 is a schematic diagram illustrating determining a merging condition according to an embodiment of the present disclosure.

FIG. 10 is a schematic diagram illustrating a form recognition process according to an embodiment of the present disclosure.

FIG. 11 is a schematic diagram illustrating a form recognition apparatus according to an embodiment of the present disclosure.

FIG. 12 is a schematic diagram illustrating a form extraction apparatus shown in an embodiment of the present disclosure.

FIG. 13 is a schematic structural diagram illustrating a form recognition device according to an embodiment of the present disclosure.

FIG. 14 is a schematic structural diagram illustrating a form extraction device according to an embodiment of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

It should be understood that the technical solutions provided by the embodiments of the present disclosure are mainly applied to the detection of small and slender objects in images, but the embodiments of the present disclosure do not limit this.

FIG. 1 shows a flowchart illustrating a form recognition method according to some embodiments of the present disclosure. As shown in FIG. 1, the method includes steps 101 to 103.

At step 101, a form line extraction process is performed on a to-be-recognized form image to obtain a form line extraction result of the to-be-recognized form image, where the form line extraction result includes a plurality of first form lines and/or a plurality of first form line intersections.

In the embodiments of the present disclosure, various methods can be used to perform the form line extraction process on the to-be-recognized form image, so as to obtain the form line extraction result of the to-be-recognized form image. The embodiments of the present disclosure do not intend to limit the specific method for obtaining the form line extraction result.

The obtained form line extraction result can include a plurality of form lines and/or a plurality of form line intersections. In order to distinguish from other form lines and intersections described as below, the form line intersections and the form lines in the form line extraction result can be referred to as first form lines and first form line intersections.

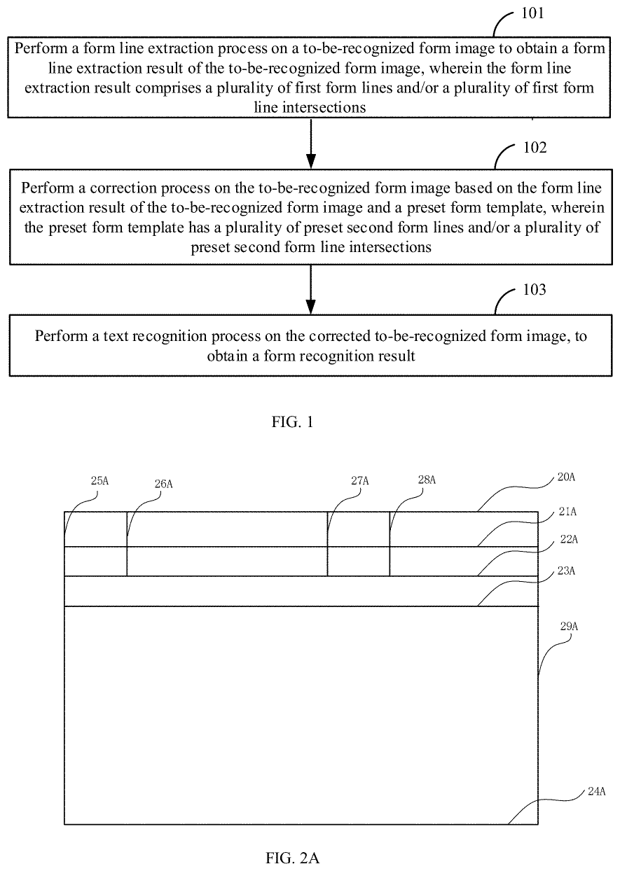

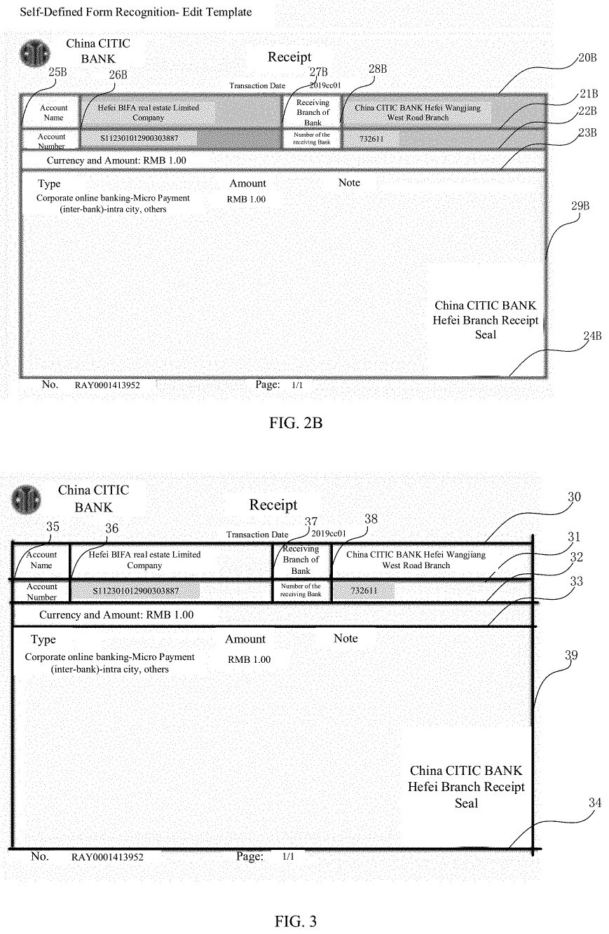

FIG. 2A shows an exemplary form line extraction result of a to-be-recognized form image. As shown in FIG. 2A, the exemplary form line extraction result includes first form lines 20A-29A. From the obtained first form lines, a plurality of first form line intersections can also be obtained. In FIG. 2A, the obtained first form lines constitute a plurality of form boxes.

At step 102, based on the form line extraction result of the to-be-recognized form image and a preset form template, a correction process is performed on the to-be-recognized form image.

The layout of the preset form template and the layout of the form in the to-be-recognized form image can be the same or similar, or partially the same or similar.

FIGS. 2A and 2B show the situation where the form line extraction result is the same as the preset form template. The preset form template shown in FIG. 2B has preset second form lines 20B-29B, and can also have a plurality of preset second form line intersections. The plurality of preset second form lines constitute a plurality of form boxes. The plurality of form boxes in FIG. 2A have a one-to-one correspondence with the plurality of form boxes in FIG. 2B.

Based on a correspondence relationship between the form line extraction result of the form image and the preset form template, the to-be-recognized form image can be corrected. The correction process includes rotation, stretch, and offset of the to-be-recognized form image, so as to make the form lines in the form image as straight as possible.

At step 103, a text recognition process is performed on the corrected to-be-recognized form image, to obtain a form recognition result.

For the corrected form image, the form lines are straight to a certain extent through the correction. Correspondingly, the text contents in the same row and/or the same column in the corrected form image are aligned to a certain extent. Therefore, by performing text recognition of the form image after the form image is corrected, the form recognition result can be obtained more accurately and quickly.

In the embodiments of the present disclosure, the to-be-recognized form image is corrected based on the form line extraction result of the form image and the preset form template, and the form recognition result is obtained by performing the text recognition on the corrected form image. Using the preset form template, the recognition of any corresponding form can be realized, and the recognition speed is fast; by correcting the to-be-recognized form image using the preset form template, the accuracy and robustness of the form recognition can be improved.

In some embodiments, the form image can be corrected in the following manner.

First, a matching process is performed on the plurality of first form lines and the plurality of second form lines to obtain a matching result of the form lines, and/or a matching process is performed on the plurality of first form line intersections and the plurality of second form line intersections, to obtain a matching result of the form line intersections.

Next, based on the matching result of the form lines and/or the matching result of the form line intersections, the to-be-recognized form image is corrected.

Taking FIGS. 2A and 2B as an example, the plurality of first form lines 20A-29A shown in FIG. 2A and the second form lines 20B-29B shown in FIG. 2B are matched, that is, a correspondence relationship between the first form lines and the second form lines is determined. For example, the first form line 20A corresponds to the second form line 20B, the first form line 21A corresponds to the second form line 21B, and so on. Similar to the matching of the form lines, the matching of the form line intersections is to determine a correspondence relationship between the plurality of first form line intersections extracted in the form image and the plurality of second form line intersections in the preset form template.

In addition, it is also possible to perform matching on the first form lines in the form image and the second form lines in the preset form template, and the first form line intersections in the form image and the second form line intersections in the preset form template in a collective way, to obtain a matching result of the form lines and a matching result of the form line intersections together.

In the embodiments of the present disclosure, the to-be-recognized form image is corrected based on the matching result of the form lines and/or the matching result of the form line intersections. In this way, the shape and distribution of the first form lines and/or the first form line intersections in the corrected form image are approximate to the preset form template, thereby achieving the form recognition result more quickly and accurately.

In some embodiments, a transformation parameter between the to-be-recognized form image and the preset form template can be obtained based on the matching result of the form lines and/or the matching result of the form line intersections, and according to the transformation parameter, a correction process is performed on the to-be-recognized form image. The matching result of the form lines includes the matching result of form line pairs of the plurality of first form lines and the plurality of second form lines, and the matching result of the form line intersections includes the matching result of form line intersection pairs of the plurality of first form line intersections and the plurality of second form line intersections.

Since the transformation parameter is obtained based on the matching result of the form lines and/or the matching result of the form line intersections, by the correction process of the to-be-recognized form image based on the transformation parameter, the shape and distribution of the first form lines and/or the first form line intersections in the transformed form image are made more approximate to the preset form template, thereby achieving the form recognition result more quickly and accurately.

According to the matching result of the form lines, it can be determined a plurality of form line pairs of the form image and of the preset form template which are successfully matched. Each form line pair includes a first form line and a second form line matched with the first form line. When the positions and directions of each first form line and of each second form line are known, the transformation parameter determined by such form line pairs can be obtained. The transformation parameter can include, for example, a transformation matrix, and each element of the transformation matrix is determined by the position and direction relationship of the first form lines and the second form lines in each form line pair. Similarly, according to the matching result of the form line intersections, the transformation parameter between the form image and the preset form template can also be determined; according to both of the matching result of the form lines and the matching result of the form line intersections, the transformation parameter between the form image and the preset form template can also be determined.

Through each matched form line pair and/or each matched form line intersection pair, the transformation parameter can be obtained, which can realize all-round correction of the to-be-recognized form image. For example, the to-be-recognized form image can be rotated such that the extension direction of each first form line is consistent with the preset form template; the to-be-recognized form image can be stretched such that curved first form line is straightened, and so on.

In some embodiments, the matching result of the form lines further includes matching confidence levels of the plurality of form line pairs, and the matching result of the form line intersections further includes matching confidence levels of the plurality of form line intersection pairs. Based on form line pairs with a matching confidence level higher than a first preset value among the plurality of form line pairs, and/or based on form line intersection pairs with a matching confidence level higher than a second preset value among the plurality of form line intersection pairs, the transformation parameter is obtained.

Assuming that the first preset value is 90% and the second preset value is 85%, in the following, taking FIG. 2A and FIG. 2B as an example, a matching result between the first form lines 20A-29A in FIG. 2A and the second form lines 20B-29B in FIG. 2B can include form line pairs (20A, 20B), (21A, 21B), . . . (29A, 29B), and the matching confidence level of each form line pair can be determined, for example, the matching confidence level of (20A, 20B) is 95%, the matching confidence level of (21A, 21B) is 85%, and so on. Therefore, the transformation parameter can be obtained from the form line pairs with a matching confidence level of more than 90%. Similarly, it is also possible to obtain the transformation parameter from the form line intersection pairs with a matching confidence level of more than 85%; and it is also possible to obtain the transformation parameter from both of the form line pairs with a matching confidence level of more than 90% and the form line intersection pairs with a matching confidence level of more than 85%.

By using form line pairs and/or form line intersection pairs with a matching confidence level higher than the preset value to obtain transformation parameter, the accuracy of the transformation parameter can be improved, such that the corrected form image can be more approximate to the preset form template.

In some cases, the to-be-recognized form image may be in a non-planar shape, and the first form lines contained therein can extend in the same direction in a certain area, but not in the same direction in the entire area. In response to this situation, transformation parameters corresponding to a plurality of areas in the preset template can be used respectively to correct the corresponding parts of the form image.

In some embodiments, a target area in the preset form template can be determined based on the matching result of the form lines and/or the matching result of the form line intersections; and based on the matching result of the form lines and/or the matching result of the form line intersections in the target area, a transformation parameter between the to-be-recognized form image and the preset form template can be obtained. The matching result corresponding to the form lines and/or the form line intersections in the target area satisfies a preset condition.

The preset condition can include any one or more the following: the number (ratio) of matching form line pairs and/or matching form line intersection pairs in the target area satisfying a first condition; and the matching confidence level corresponding to the matching form line pairs and/or matching form line intersection pairs in the target area satisfying a second condition.

Assuming that the number satisfying the first condition is larger than 10, or the ratio (the number against the total number of form lines and/or the total number of form line intersections) is higher than 50%, and the matching confidence level satisfying the second condition means the matching confidence level is higher than 90%. When the matching result of form lines and/or the matching result of form line intersections between the form image and the preset form template is known, for the preset form template, an area with a number of matching form lines and/or matching form line intersections being larger than 10 (the ratio thereof being higher than 50%) in the preset form template is determined as the target area. Alternatively, an area with a matching confidence level corresponding to the matching form line pairs and/or the matching form line intersection pairs being higher than 90% in the preset form template is determined as the target area. Alternatively, an area with a ratio higher than 50% and a matching confidence level corresponding to the matching form line pairs and/or the matching form line intersection pairs being higher than 90% in the preset form template is determined as the target area.

When the preset form template includes at least two template areas, a corresponding target area can be determined for each template area, and based on the matching result corresponding to the form lines and/or the form line intersections in the target area of each template area, the transformation parameter corresponding to each template area is obtained.

In the embodiments of the present disclosure, corresponding transformation parameters are obtained for a plurality of template areas in the preset form template, thereby realizing independent correction of each part of the to-be-recognized form image. When the various parts of the overall form image are deformed and distorted inconsistently, a better correction effect can be achieved.

In one example, in response to the ratio of matching form line pairs in the plurality of first form lines reaching a first ratio value, and/or in response to the matching form line intersection pairs in the plurality of first form line intersections reaching a second ratio value, based on the form line extraction result of the to-be-recognized form image and the preset form template, a correction process is performed on the to-be-recognized form image.

For example, when the ratio of the matching form line pairs in the first form lines reaches 50%, and/or the ratio of the matching form line intersection pairs in the first form line intersections reaches 50%, it is confirmed that the to-be-recognized form image is successfully matched with the preset form template, and the to-be-recognized form image can be corrected based on the form line extraction result of the to-be-recognized form image and the preset form template.

When the form image is successfully matched with the preset form template, a further correction process of the to-be-recognized form image can be performed to ensure the accuracy of the correction process and the accuracy of the form recognition result.

In some embodiments, text detection is performed on the corrected form image to obtain a plurality of text detection boxes of the to-be-recognized form image. According to the relative position of each text detection box, the form boxes, which are defined by the plurality of first form lines, corresponding to the text detection boxes are determined. Next, text recognition is performed on the plurality of text detection boxes to obtain a text recognition result. Finally, the form recognition result is obtained based on an intersection-over-union ratio between the plurality of text detection boxes and the plurality of form boxes defined by the plurality of first form lines. For example, when the intersection-over-union ratio between the text detection box and the corresponding form box is greater than 60%, it is determined that the content in the text detection box does belong to the form box, so the text recognition result in the text detection box is filled into the corresponding form box.

After performing the above operations on the text detection box, the correspondence between the text recognition result in the text detection box and the form box can be realized to obtain the form recognition result.

In the embodiments of the present disclosure, the form recognition result is obtained based on the intersection-over-union ratio of the text detection box and the form box, which ensures the correspondence between the content in the text detection box and the form box, and improves the accuracy of the form recognition result.

In some embodiments, at least one to-be-detected target form box can be determined from the plurality of form boxes defined by the plurality of first form lines in the to-be-recognized form image based on the preset form template. Next, text recognition is performed on the at least one target form box, to obtain a text recognition result of each target form box in the at least one target form box. Finally, based on the text recognition result of the at least one target form box, the form recognition result is obtained.

When the target to be recognized includes the content of a certain number of form boxes instead of the content of the entire form, the speed and efficiency of form recognition can be improved by determining the to-be-detected target form boxes for text recognition.

In the embodiments of the present disclosure, the to-be-detected target form boxes can be determined by a preset form template, such that text recognition is performed on the target form boxes, and the form recognition result of these target form boxes are obtained.

In some embodiments, at least one target form box in the plurality of form boxes of the preset form template can be determined by a recognition condition input by a user. Taking FIG. 2B as an example, the recognition condition from the user can be to recognize the text content of the form box corresponding to an account name and an account number, and then it can be determined that the target form box to be detected is the form box corresponding to the account name (not the form box where the “account name” is located, but the form box where the content corresponding to the “account name” is located), and the form box corresponding to the account number (not the form box where the “account number” is located, but the form box where the content corresponding to the “account number” is located).

In some embodiments, a certain attribute can be set for the target form box, and the form recognition result can be obtained based on the attribute of the target form box and the text recognition result of the target form box.

For example, in the preset form template, the target form box to be detected is selected as the form box corresponding to the content of the account number, and the attribute of the target form box is set to “account number”, then when text recognition is performed on the target form box, the attribute “account number” of the target form box and the content of the form box are used as the form recognition result.

In some embodiments, the preset form template can be obtained from a reference form image. The reference form image refers to a form image that has the same or similar layout, or partially the same or similar layout, as the to-be-recognized form image.

First, a form line extraction process can be performed on the reference form image to obtain a form line extraction result of the reference form image. The method of performing the form line extraction process can be the same as or different from the form line extraction process method used at step 101, which is not limited in this embodiment.

For the form line extraction result, the user input can be used to modify the form line extraction result to obtain a preset form template with clearer form lines. For example, it is possible to manually redraw the lines by operating the mouse on the basis of the original form line extraction result.

FIG. 3 shows a schematic diagram of modifying a preset form template. In FIG. 3, the form lines 30, 31, 32, 34, 35, 39 are form lines after the modification process, and the other form lines are not modified. It can be seen from FIG. 3 that the modified form lines are clearer than the unmodified form lines. Therefore, the quality of the preset form template obtained by modifying the form line extraction result is improved.

Those skilled in the art should understand that FIGS. 2B and 3 are only for illustration, and whether the content in the form is clear does not affect the understanding of the solutions of the embodiments of the present disclosure.

FIG. 4 is a flowchart illustrating another form recognition method shown in an embodiment of the present disclosure. As shown in FIG. 4, the method includes steps 401 to 403.

At step 401, a form line extraction process is performed on a reference form image to obtain a form line extraction result of the reference form image.

In the embodiments of the present disclosure, the reference form image can be any form image, and the reference form image can be subjected to a form line extraction process in a variety of ways, so as to obtain the form line extraction result of the reference form image. The embodiments of the present disclosure do not intend to limit the specific method for obtaining the form line extraction result.

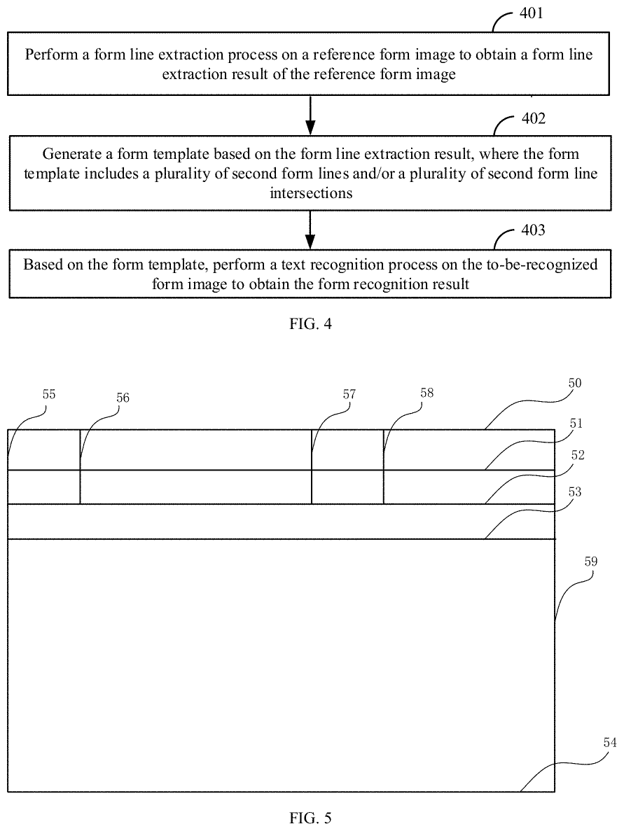

An example of the form line extraction result of the reference form image is shown in FIG. 5, which includes the second form lines 50-59.

At step 402, a form template is generated based on the form line extraction result, where the form template includes a plurality of second form lines and/or a plurality of second form line intersections.

Taking the form line extraction result shown in FIG. 5 as an example, the form template generated based on the second form lines 50˜59 can include the second form lines 50˜59, can also include a plurality of second form line intersections obtained from the second form lines, and can also include both of the second form lines 50˜59 and the plurality of second form line intersections.

In the generated form template, the plurality of second form lines constitutes a plurality of form boxes.

In some embodiments, after the form line extraction result is obtained at step 401, the form line extraction result can be displayed, for example, the form line extraction result shown in FIG. 5 is displayed; and in response to receiving confirmation instruction from the user, a form template is generated based on the form line extraction result.

After obtaining the form line extraction result, the form template is generated after confirmation of the user, the accuracy of the generated form template can be ensured.

In some embodiments, after the form line extraction result is obtained at step 401, in response to receiving an adjustment instruction from the user, the form line extraction result is adjusted to obtain an adjustment result; and the form template is generated based on the adjustment result.

By adjusting the form line extraction result and then generating the form template, the accuracy of the generated form template can be ensured.

At step 403, based on the form template, a text recognition process is performed on the to-be-recognized form image to obtain the form recognition result.

The layout of the to-be-recognized form image and the layout of the form template can be the same or similar, or partially the same or similar.

In the embodiments of the present disclosure, the form template is generated based on the form line extraction result of the reference form image, to realize the recognition of the to-be-recognized form image, and the recognition speed and the accuracy is high. In some embodiments, the method further includes receiving a recognition instruction from the user, where the recognition instruction is used to indicate a target form entry in the form template that needs to be recognized; and based on the form template, a text recognition process is performed on the target form entry in the to-be-recognized form image, to obtain a form recognition result.

The user can instruct to set one or more form boxes in the form template as target form entries that need to be recognized. When performing the text recognition process on the to-be-processed form image, corresponding form boxes in the to-be-recognized form image can be determined according to the target form entries in the form template, and a text recognition process can be performed on the content in the form boxes, to obtain the form recognition result.

By setting the target form entry to be recognized, and performing text recognition on the corresponding form box in the to-be-recognized form image, the recognition efficiency of the form can be improved.

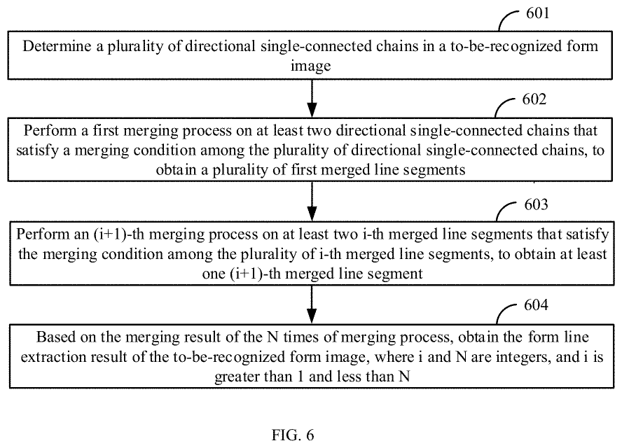

FIG. 6 is a flowchart illustrating a form extraction method shown in an embodiment of the present disclosure. The method is used to perform a form line extraction process on the to-be-recognized form image to obtain the form line extraction result of the to-be-recognized form image. As shown in FIG. 6, the method includes steps 601-604.

At step 601, a plurality of directional single-connected chains in a to-be-recognized form image is determined.

The directional single-connected chain is composed of connected runs in the corresponding direction, and the run is a continuous pixel strip. A directional single-connected chain usually includes a horizontal single-connected chain and a longitudinal single-connected chain. Correspondingly, the run also usually includes a horizontal run and a longitudinal run.

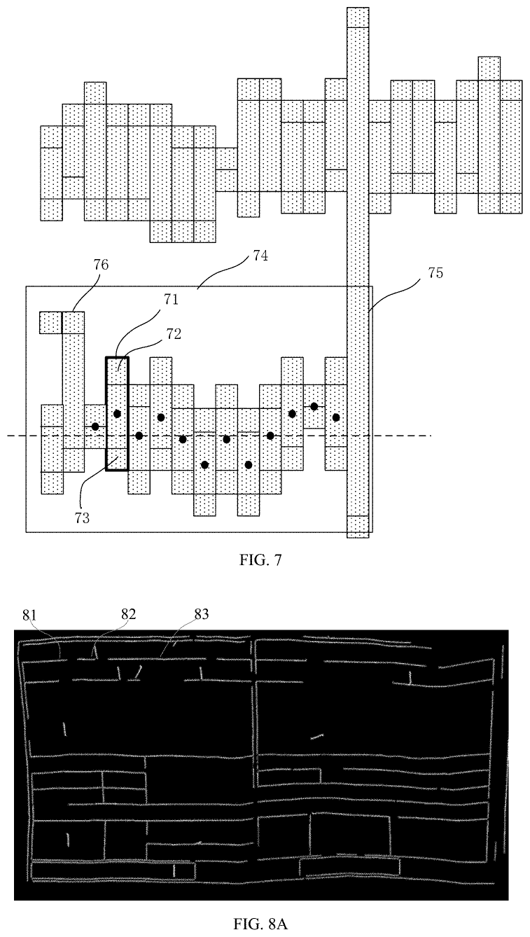

FIG. 7 shows a schematic diagram of an exemplary directional single-connected chain. FIG. 7 contains a plurality of longitudinal runs. For example, the run 71 is a longitudinal run, where the pixel 72 is the start pixel of the run; the pixel 73 is the end pixel of the run. For the longitudinal run, the start pixel and the end pixel are aligned in the longitudinal direction (not shown in FIG. 7). Similarly, for the horizontal run, the start pixel and the end pixel are aligned in the horizontal direction. As shown in FIG. 7, a plurality of horizontally connected longitudinal runs in the box 74 constitute a horizontal single-connected chain. In the same way, a plurality of longitudinally connected horizontal runs constitutes a longitudinal connected chain (not shown in FIG. 7).

In some embodiments, a plurality of directional connected chains in the form image can be determined in the following manner. First, binary data of the to-be-recognized form image is obtained. That is, all pixels in the form image are binarized, and each pixel is either a black pixel or a white pixel. In the binarized form image, the black form lines correspond to black pixels, and the background part corresponds to white pixels. It is also possible to make the black form lines correspond to white pixels, and the background part correspond to black pixels. Next, according to the binary data, a plurality of runs along a first direction is obtained. Then, according to at least two runs connected in a second direction of the plurality of runs, the plurality of directional single-connected chains are determined.

When the first direction is the longitudinal direction and the second direction is the horizontal direction, a plurality of longitudinal runs are obtained, and a plurality of horizontal single-connected chains are determined based on at least two longitudinal runs connected in the horizontal direction; When the first direction is the horizontal direction and the second direction is the longitudinal direction, a plurality of horizontal runs are obtained, and a plurality of longitudinal single-connected chains are determined based on at least two horizontal runs connected in the longitudinal direction.

In some embodiments, a first run of the plurality of runs can also be removed to obtain a plurality of remaining runs, where one side of the first run has at least two adjacent runs. According to at least two runs connected in the second direction of the plurality of remaining runs, the plurality of directional single-connected chains are determined.

Any one of the runs within a directional single-connected chain (except both ends) has only one run adjacent thereto on either side. As shown in FIG. 7, the run 71 inside the directional single-connected chain has one run adjacent thereto on either side. The run 75 has two adjacent runs on the left side, and the run 76 also has two adjacent runs on the left side. Therefore, the run 75 and the run 76 can be removed, and the remaining runs can be used to determine the directional single-connected chain.

In the form detection, it is difficult to separate the form line and the text when they stick or overlap with each other, which leads to the difficulty of detecting the form line. Corresponding to form line extraction using a directional single-connected chain, when there is a text that is stuck or overlapped with the form line, there are two or more adjacent runs on both sides or on one side of the corresponding run. Such a run can be filtered out, such that the form lines can be extracted more accurately and the text can be avoided from being deleted by mistake.

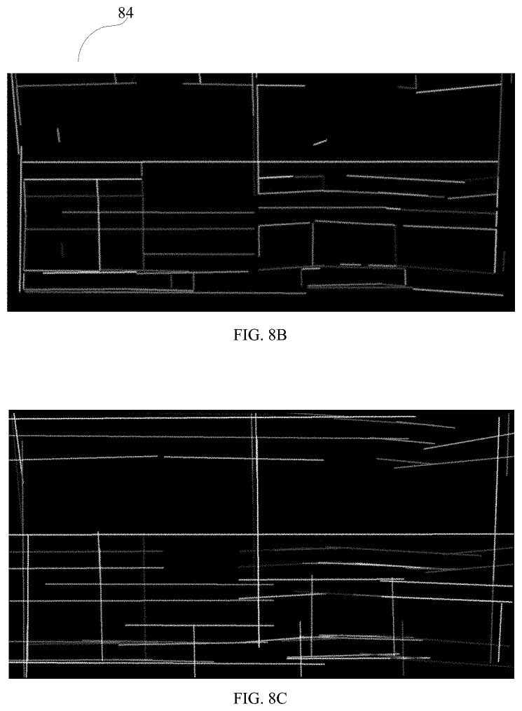

Through the above method, it is possible to determine the plurality of directional single-connected chains included in the form image, including a plurality of horizontal single-connected chains and a plurality of longitudinal single-connected chains. FIG. 8A shows a schematic diagram of a plurality of directional single-connected chains obtained from a form image. For apparent illustration, these directional single-connected chains are exemplarily represented with black background and white pixels.

At step 602, a first merging process is performed on at least two directional single-connected chains that satisfy a merging condition among the plurality of directional single-connected chains, to obtain a plurality of first merged line segments.

Due to the influence of noise, the plurality of directional single-connected chains determined from the form image can be broken, as shown in FIG. 8A, so the broken directional single-connected chains need to be merged to solve the problem of breaking form lines.

In order to avoid merging two or more directional single-connected chains that do not originally belong to the same form line, a reasonable merging condition needs to be set. According to a distance, positions, a slope and other information of the two directional single-connected chains, it can be decided whether the two directional single-connected chains satisfy the merging condition. For a plurality of directional single-connected chains, if each of the plurality of directional single-connected chains satisfies the merging condition with any of the others, it can be said that the plurality of directional single-connected chains comply with the merging condition, and the first merging process is performed on the plurality of directional single-connected chains. After merging all the directional single-connected chains in the image that satisfy the merging condition, a plurality of first merged line segments can be obtained.

Take the plurality of directional connected chains shown in FIG. 8A as an example, where the chain 81 and the chain 82 satisfy the merging condition, and the chain 82 and the chain 83 satisfy the merging condition, then the chain 81, chain 82 and chain 83 are said to satisfy the merging condition, and these three directional single-connected chains are merged to obtain a first merged line segment 84 (see FIG. 8B).

In some embodiments, at least two directional single-connected chains can be merged in the following way. First, a midpoint of each run in each directional single-connected chain is determined, and the midpoints of the plurality of runs included in the plurality of directional single-connected chains are fit to obtain the first merged line segment.

FIG. 7 shows a schematic diagram of line segments obtained by fitting the midpoints of a plurality of runs. As shown in FIG. 7, black dots in the runs represents the midpoints of the runs. By fitting the midpoints of the runs, the corresponding line segment (the location of the dashed line is the location of the line segment obtained by fitting) can be obtained. Information such as the end points and slope of the line segment obtained by the fitting can also be stored for use in the subsequent further merging process.

In some embodiments, the merging condition includes any one or more of the following: a minimum distance between the end points of the two to-be-merged objects being less than a first threshold; a first maximum distance between the end points of the two to-be-merged objects being less than a second threshold; and a second maximum distance from the end points of the two to-be-merged objects to a connection line corresponding to the first maximum distance between the end points of the two to-be-merged objects being less than a second threshold; where the to-be-merged object is a directional single-connected chain or an i-th merged line segment.

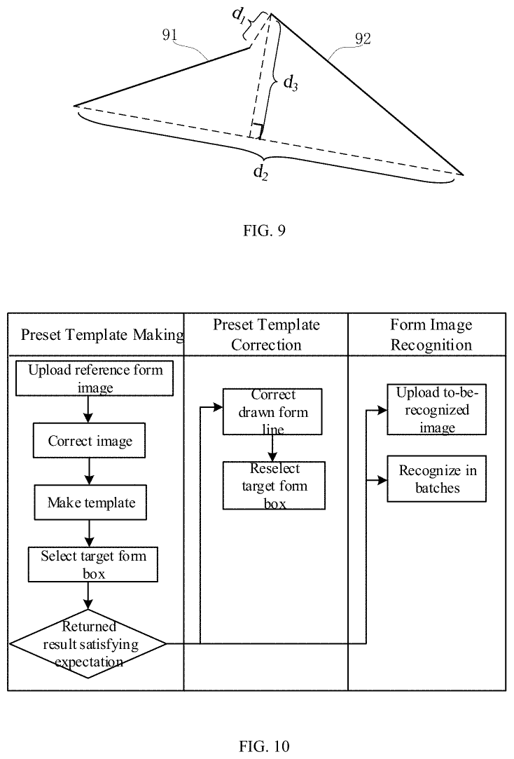

Taking the directional single-connected chain 91 and the directional single-connected chain 92 shown in FIG. 9 as an example, the merging condition includes any one or more of the following: a minimum distance d1 between the end points of the chain 91 and the chain 92 being less than a first threshold; a maximum distance d2 between the end points of the chain 91 and the chain 92 being less than a second threshold; and a maximum distance d3 from the end points of the chain 91 and the chain 92 to a connection line corresponding to d2 being less than a second threshold. The first threshold and the second threshold can be specifically set according to the accuracy requirements for form line extraction.

At step 603, at least two i-th merged line segments that satisfy the merging condition among the plurality of i-th merged line segments are subjected to an (i+1)-th merging process, to obtain at least one (i+1)-th merged line segment.

For the plurality of first merged line segments obtained at step 602, the merging can be continued according to the merging condition. In the (i+1)-th merging process, at least two i-th merged line segments that satisfy the merging condition are merged to obtain at least one (i+1)-th merged line segment.

In some embodiments, at least two i-th merged line segment can be merged in the following manner to obtain the (i+1)th merged line segment: determining a midpoint of each run in the directional single-connected chain included in the i-th merged line segment, and fitting the midpoints of the plurality of runs included in the i-th merged line segments to be merged, to obtain the (i+1)-th merged line segment.

In some embodiments, at least one end of the i-th merged line segment can be extended with at least one pixel to obtain an extended line segment of the i-th merged line segment; based on the extended line segment of each i-th merged line segment in the plurality of i-th merged line segments, at least two i-th merged line segments that satisfy the merging condition are determined from the plurality of i-th merged line segments.

For example, for the fourth merging process, either end of the third merged line segment can be extended by three pixels, to obtain the extended line segment of the third merged line segment. By deciding whether the extended line segments of the plurality of third merged line segments satisfy the merging condition, and performing a merging process on the third merged line segments that satisfy the merging condition, a plurality of fourth merged line segments can be obtained.

Due to the influence of noise, the originally continuous line segment can be broken, and the span of the break can be too large to satisfy the merging condition. By extending the line segment to determine whether it satisfies the merging condition, this problem can be solved, and the extracted form line is more complete.

At step 604, based on the merging result of the N times of merging process, the form line extraction result of the to-be-recognized form image is obtained, where i and N are integers, and i is greater than 1 and less than N.

FIG. 8C shows an exemplary form line extraction result. As shown in FIG. 8C, by extending the merged line segment to further determine whether the merging condition is satisfied, the break of the form line can be further repaired.

It should be understood that the form extraction method provided in the embodiment of the present disclosure can be applied to any form image, for example, the to-be-recognized form image or the reference form image mentioned above, which is not limited in the embodiment of the present disclosure.

FIG. 10 is a schematic diagram of a form recognition process according to an embodiment of the present disclosure. As shown in FIG. 10, the form recognition process mainly includes three stages: a preset template making stage, a preset template correction stage, and a form image recognition stage.

In the preset template making stage, first a reference form image is uploaded, which has a layout the same or partially the same as the layout of the to-be-recognized form image. Next, the reference form image is corrected, for example, perspective transformation is performed, or the deformation is adjusted, such that the form lines in the reference form image are straight and the form box shape is regular. After that, a preset template can be made by drawing the form lines in the form, or the preset template can be made by extracting the form lines in the reference form image. For the form boxes defined by a plurality of form lines, a preset number of form boxes with preset positions can be selected as the target form boxes to be detected for text content recognition in the subsequent form image recognition stage.

When the form image recognition result does not satisfy expectations, it enters the preset template correction stage. It is possible to edit the already drawn form lines, such as redrawing the form lines, or bolding or straightening the form lines to obtain a clearer and straighter form lines. After correcting the form lines, it is also possible to reselect a target form box to redefine the area to be recognized.

When the form image recognition result satisfies expectations, it can enter the form image recognition stage. The uploaded form image to be recognized can be recognized individually, or a plurality of form images can be recognized in batches, for example, through API to achieve batch recognition.

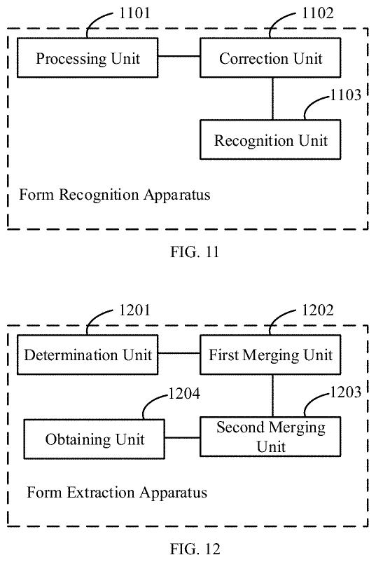

FIG. 11 provides a form recognition apparatus. As shown in FIG. 11, the apparatus can include: a processing unit 1101 configured to perform a form line extraction process on a to-be-recognized form image to obtain a form line extraction result of the to-be-recognized form image, where the form line extraction result includes a plurality of first form lines and/or a plurality of first form line intersections; a correction unit 1102 configured to, based on the form line extraction result of the to-be-recognized form image and a preset form template, perform a correction process on the to-be-recognized form image, where the preset form template has a plurality of preset second form lines and/or a plurality of preset second form line intersections; a recognition unit 1103 configured to perform a text recognition process on the corrected to-be-recognized form image, to obtain a form recognition result.

In some embodiments, the correction unit 1102 is specifically configured to perform a matching process on the plurality of first form lines and the plurality of second form lines to obtain a matching result of the form lines, and/or perform a matching process on the plurality of first form line intersections and the plurality of second form line intersections, to obtain a matching result of the form line intersections; and based on the matching result of the form lines and/or the matching result of the form line intersections, correct the to-be-recognized form image.

In some embodiments, when the correction unit 1102 is configured to perform a correction process on the to-be-recognized form image based on the matching result of the form lines and/or the matching result of the form line intersections, the correction unit 1102 is specifically configured to obtain a transformation parameter between the to-be-recognized form image and the preset form template based on the matching result of the form lines and/or the matching result of the form line intersections, where the matching result of the form lines includes the matching result of a plurality of form line pairs of the plurality of first form lines and the plurality of second form lines, and the matching result of the form line intersections includes the matching result of a plurality of form line intersection pairs of the plurality of first form line intersections and the plurality of second form line intersections; and according to the transformation parameter, perform a correction process on the to-be-recognized form image.

In some embodiments, when the correction unit 1102 is configured to obtain a transformation parameter between the to-be-recognized form image and the preset form template based on the matching result of the form lines and/or the matching result of the form line intersections, the correction unit 1102 is specifically configured to obtain a transformation parameter between the to-be-recognized form image and the preset form template based on matched form line pairs in the plurality of form line pairs, and/or based on matched form line intersection pairs in the plurality of form line intersection pairs.

In some embodiments, the matching result of the form lines includes matching confidence levels of the plurality of form line pairs, and the matching result of the form line intersections further includes matching confidence levels of the plurality of form line intersection pairs. When the correction unit 1102 is configured to obtain a transformation parameter between the to-be-recognized form image and the preset form template based on the matching result of the form lines and/or the matching result of the form line intersections, the correction unit 1102 is specifically configured to obtain the transformation parameter based on the form line pairs with a matching confidence level higher than a first preset value among the plurality of form line pairs, and/or based on the form line intersection pairs with a matching confidence level higher than a second preset value among the plurality of form line intersection pairs.

In some embodiments, when the correction unit 1102 is configured to obtain a transformation parameter between the to-be-recognized form image and the preset form template based on the matching result of the form lines and/or the matching result of the form line intersections, the correction unit 1102 is specifically configured to determine a target area in the preset form template based on the matching result of the form lines and/or the matching result of the form line intersections, where the matching result of the form lines and/or the form line intersections in the target area satisfies a preset condition; and obtain a transformation parameter between the to-be-recognized form image and the preset form template based on the matching result corresponding to the form lines and/or the matching result of the form line intersections in the target area.

In some embodiments, the preset form template includes at least two template areas, and when the correction unit 1102 is configured to determine a target area in the preset form template based on the matching result of the form lines and/or the matching result of the form line intersections, the correction unit 1102 is specifically configured to obtain a corresponding target area for each of the at least two template areas based on the matching result of the form lines and/or the matching result of the form line intersections, and obtaining a transformation parameter between the to-be-recognized form image and the preset form template based on the matching result of the form lines and/or the matching result of the form line intersections in the target area includes: obtaining the transformation parameter corresponding to each template area based on the matching result corresponding to the form lines and/or the form line intersections in the target area of each of the at least two template areas.

In some embodiments, the preset condition can include any one or more the following: the number (ratio) of matching form line pairs and/or matching form line intersection pairs in the target area satisfying a first condition; and the matching confidence level corresponding to the matching form line pairs and/or matching form line intersection pairs in the target area satisfying a second condition.

In some embodiments, when the correction unit 1102 is configured to, based on the form line extraction result of the to-be-recognized form image and a preset form template, perform a correction process on the to-be-recognized form image, the correction unit 1102 is specifically configured to, in response to the ratio of matching form line pairs in the plurality of first form lines reaching a first ratio value, and/or in response to the ratio of matching form line intersection pairs in the plurality of first form line intersections reaching a second ratio value, based on the form line extraction result of the to-be-recognized form image and the preset form template, perform a correction process on the to-be-recognized form image.

In some embodiments, the recognition unit 1101 is specifically configured to perform text detection on the corrected form image to obtain a plurality of text detection boxes of the to-be-recognized form image; perform text recognition on the plurality of text detection boxes to obtain a text recognition result; and obtain the form recognition result based on an intersection-over-union ratio between the plurality of text detection boxes and the plurality of form boxes defined by the plurality of first form lines.

In some embodiments, the recognition unit 1101 is specifically configured to determine at least one to-be-detected target form box from the plurality of form boxes defined by the plurality of first form lines in the to-be-recognized form image based on the preset form template; perform text recognition on the at least one target form box, to obtain a text recognition result of each target form box in the at least one target form box; and based on the text recognition result of the at least one target form box, obtain the form recognition result.

In some embodiments, when the recognition unit 1101 is configured to determine at least one to-be-detected target form box from the plurality of form boxes defined by the plurality of first form lines in the to-be-recognized form image based on the preset form template, the recognition unit 1101 is specifically configured to receive a recognition condition entered by a user; and determine at least one target form box from a plurality of form boxes of the preset form template based on the recognition condition.

In some embodiments, the apparatus further includes a setting unit configured to set an attribute for the target form box, and when the recognition unit is configured to, based on the text recognition result of the at least one target form box, obtain the form recognition result, the recognition unit is specifically configured to obtain the form recognition result based on the attribute of the target form box and the text recognition result of the target form box.

In some embodiments, the apparatus further includes a template obtaining unit configured to perform a form line extraction process on a reference form image to obtain a form line extraction result of the reference form image; and based on user input, perform a correction process on the form line extraction result of the reference form image, to obtain the preset form template.

FIG. 12 shows a schematic diagram of a form extraction apparatus according to an embodiment of the present disclosure. As shown in FIG. 12, the apparatus includes: a determination unit 1201 configured to determine a plurality of directional single-connected chains in a to-be-recognized form image; a first merging unit 1202 configured to perform a first merging process on at least two directional single-connected chains that satisfy a merging condition among the plurality of directional single-connected chains, to obtain a plurality of first merged line segments; a second merging unit 1203 configured to perform an (i+1)-th merging process on at least two i-th merged line segments that satisfy the merging condition among the plurality of i-th merged line segments, to obtain at least one (i+1)-th merged line segment; an obtaining unit 1204 configured to, based on the merging result of the N times of merging process, obtain the form line extraction result of the to-be-recognized form image, where i and N are integers, and i is greater than 1 and less than N.

In some embodiments, the apparatus further includes an extension unit configured to extend at least one end of the i-th merged line segment with at least one pixel to obtain an extended line segment of the i-th merged line segment; based on the extended line segment of each i-th merged line segment in the plurality of i-th merged line segments, determine at least two i-th merged line segments that satisfy the merging condition from the plurality of i-th merged line segments.

In some embodiments, when the determination unit is configured to determine a plurality of directional single-connected chains in a to-be-recognized form image, the determination unit is specifically configured to obtain binary data of the to-be-recognized form image; according to the binary data, obtain a plurality of runs along a first direction; and according to at least two runs connected in a second direction of the plurality of runs, determine the plurality of directional single-connected chains.

In some embodiments, the apparatus further includes a removing unit configured to remove a first run of the plurality of runs, to obtain a plurality of remaining runs, where one side of the first run has at least two adjacent runs. When the determination unit is configured to according to at least two runs connected in a second direction of the plurality of runs, determine the plurality of directional single-connected chains, the determination unit is specifically configured to according to at least two runs connected in the second direction of the plurality of remaining runs, determine the plurality of directional single-connected chains.

In some embodiments, the merging condition includes any one or more of the following: a minimum distance between the end points of the two to-be-merged objects being less than a first threshold; a first maximum distance between the end points of the two to-be-merged objects being less than a second threshold; and a second maximum distance from the end points of the two to-be-merged objects to a connection line corresponding to the first maximum distance between the end points of the two to-be-merged objects being less than a second threshold; where the to-be-merged object is a directional single-connected chain or an i-th merged line segment.

In some embodiments, when the second merging unit is configured to perform an (i+1)-th merging process on at least two i-th merged line segments, to obtain at least one (i+1)-th merged line segment, the second merging unit is specifically configured to determine a midpoint of each run in the directional single-connected chain included in the i-th merged line segments, and perform fitting according to the midpoints of the plurality of runs included in the i-th merged line segments to be merged, to obtain the (i+1)-th merged line segment.

It should be understood that the apparatus provided in the embodiments of the present disclosure can be used to execute any of the foregoing embodiments and methods, and accordingly include modules or units for executing the steps and/or processes in any of the foregoing embodiments and methods. For brevity, the details of which will be omitted.

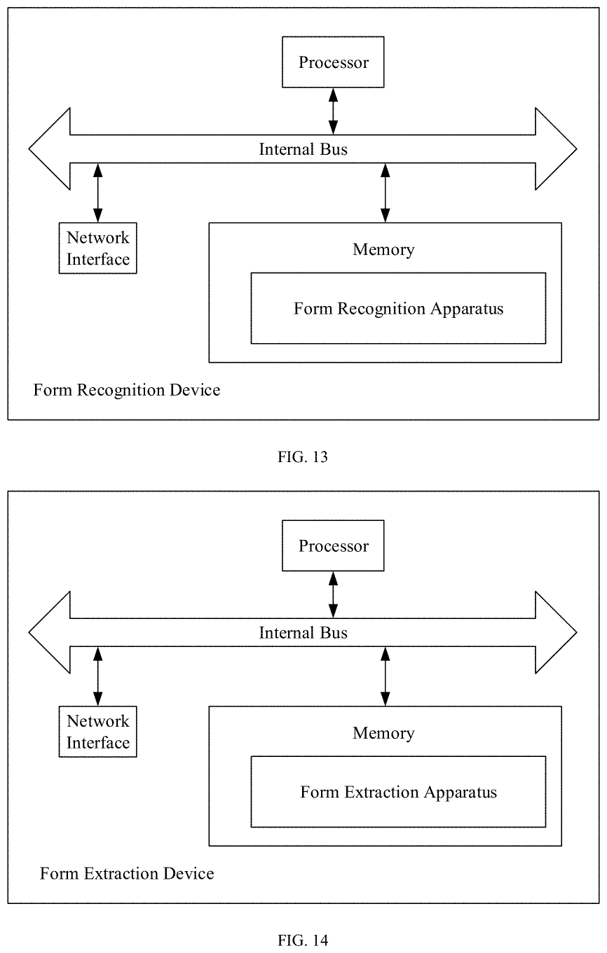

FIG. 13 is a form recognition device provided by at least one embodiment of the present disclosure. The device includes a memory and a processor. The memory is configured to store computer instructions that can be executed on the processor. The processor is configured to, when executing the computer instructions, implement the form recognition method according to any embodiment of the present disclosure.

FIG. 14 is a form extraction device provided by at least one embodiment of the present disclosure. The device includes a memory and a processor. The memory is configured to store computer instructions that can be executed on the processor. The processor is configured to, when executing the computer instructions, implement the form extraction method according to any embodiment of the present disclosure.

At least one embodiment of the present disclosure further provides a computer-readable storage medium on which a computer program is stored, and when the program is executed by a processor, the form recognition method according to any embodiment of the present disclosure is implemented.

At least one embodiment of the present disclosure further provides a computer-readable storage medium on which a computer program is stored, and when the program is executed by a processor, the form extraction method according to any embodiment of the present disclosure is implemented.

Those skilled in the art should understand that one or more embodiments of this specification can be provided as a method, a system, or a computer program product. Therefore, one or more embodiments of this specification can adopt the form of a complete hardware embodiment, a complete software embodiment, or an embodiment combining software and hardware. Moreover, one or more embodiments of this specification may adopt the form of a computer program product implemented on one or more computer-usable storage media (including but not limited to disk storage, CD-ROM, optical storage, etc.) containing computer-usable program code.

Embodiments of this specification also provide a computer-readable storage medium storing a computer program, which when executed by a processor, implement the steps of the form recognition method described in any embodiment of this specification, and/or the form extraction method described in any embodiment of this specification. Wherein “and/or” means at least one of the two, for example, “A and/or B” includes three options: A, B, and “A and B”.

The various embodiments in this specification are described in a progressive manner, and the same or similar parts between the various embodiments can be referred to each other. Each embodiment focuses on the differences from other embodiments. In particular, as for the data processing device embodiment, since it is basically similar to the method embodiment, the description is relatively simple, and for related parts, reference can be made to the partial description of the method embodiment.

The foregoing describes specific embodiments of this specification. Other embodiments are within the scope of the appended claims. In some cases, the actions or steps described in the claims can be performed in a different order than in the embodiments and still achieve desired result. In addition, the processes depicted in the drawings do not necessarily require the specific order or sequential order shown to achieve the desired result. In some embodiments, multitasking and parallel process are also possible or can be advantageous.

The embodiments of the subject and functional operations described in this specification can be implemented in the following: digital electronic circuits, tangible computer software or firmware, computer hardware including the structures disclosed in this specification and their structural equivalents, or a combination of one or more thereof The embodiments of the subject matter described in this specification can be implemented as one or more computer programs, that is, one or more modules of computer program instructions encoded on a tangible non-transitory program carrier to be executed by a data processing device or to control the operation of the data processing device. Alternatively or in addition, the program instructions can be encoded on artificially generated propagated signals, such as machine-generated electrical, optical or electromagnetic signals, which are generated to encode information and transmit it to a suitable receiver device to be executed by the processing device. The computer storage medium can be a machine-readable storage device, a machine-readable storage substrate, a random or serial access memory device, or a combination of one or more thereof.

The process and logic flows described in this specification can be executed by one or more programmable computers executing one or more computer programs to perform corresponding functions by operating according to input data and generating output. The process and logic flow can also be executed by a dedicated logic circuit, such as FPGA (Field Programmable Gate Array) or ASIC (Application Specific Integrated Circuit), and the device can also be implemented as a dedicated logic circuit.

Computers suitable for executing computer programs include, for example, general-purpose and/or special-purpose microprocessors, or any other type of central processing unit. Generally, the central processing unit will receive instructions and data from a read-only memory and/or random access memory. The basic components of a computer include a central processing unit for implementing or executing instructions and one or more memory devices for storing instructions and data. Generally, the computer will also include one or more mass storage devices for storing data, such as magnetic disks, magneto-optical disks, or optical disks, or the computer will be operatively coupled to this mass storage device to receive data from or send data to it, or both. However, the computer does not have to have such equipment. In addition, the computer can be embedded in another device, such as a mobile phone, a personal digital assistant (PDA), a mobile audio or video player, a game console, a global positioning system (GPS) receiver, or a portable storage device with a universal serial bus (USB) flash drive, to name a few.

Computer-readable media suitable for storing computer program instructions and data include all forms of non-volatile memories, media, and memory devices, including, for example, semiconductor memory devices (such as EPROM, EEPROM, and flash memory devices), magnetic disks (such as internal Hard disk or removable disk), magneto-optical disk and CD ROM and DVD-ROM disk. The processor and the memory can be supplemented by or incorporated into a dedicated logic circuit.

Although this specification contains many specific implementation details, these should not be construed as limiting the scope of any invention or the scope of protection, but are mainly used to describe the features of specific embodiments of a particular invention. Certain features described in a plurality of embodiments in this specification can also be implemented in combination in a single embodiment. On the other hand, various features described in a single embodiment can also be implemented in a plurality of embodiments separately or in any suitable sub-combination. In addition, although features can function in certain combinations as described above and even initially claimed as such, one or more features from the claimed combination can in some cases be removed from the combination, and the claimed combination of protection can be directed to a sub-combination or a variant of the sub-combination.

Similarly, although operations are depicted in a specific order in the drawings, this should not be understood as requiring these operations to be performed in the specific order shown or sequentially, or requiring all illustrated operations to be performed, to achieve the desired result. In some cases, multitasking and parallel process can be advantageous. In addition, the separation of various system modules and components in the above embodiments should not be understood as requiring such separation in all embodiments, and it should be understood that the described program components and systems can usually be integrated together in a single software product, or packaged into a plurality of software products.

Thus, specific embodiments of the subject matter have been described. Other embodiments are within the scope of the appended claims. In some cases, the actions recited in the claims can be performed in a different order and still achieve desired result. In addition, the processes depicted in the drawings are not necessarily in the specific order or sequential order shown in order to achieve the desired result. In some implementations, multitasking and parallel process can be advantageous.

What is claimed is:

1. A form recognition method performed by a computing device, the method comprising:
obtaining a form line extraction result of a to-be-recognized form image by performing a form line extraction process on the to-be-recognized form image, wherein the form line extraction result comprises at least one of a plurality of first form lines or a plurality of first form line intersections;
obtaining a corrected to-be-recognized form image by performing a correction process on the to-be-recognized form image based on the form line extraction result of the to-be-recognized form image and a preset form template, wherein the preset form template has at least one of a plurality of preset second form lines or a plurality of preset second form line intersections; and
performing a text recognition process on the corrected to-be-recognized form image to obtain a form recognition result.

2. The method of claim 1, wherein obtaining a corrected to-be-recognized form image comprises:
obtaining at least one of
a matching result of form lines by performing a matching process on the plurality of first form lines and the plurality of second form lines or
a matching result of form line intersections by performing a matching process on the plurality of first form line intersections and the plurality of second form line intersections; and
obtaining the corrected to-be-recognized form image by performing the correction process on the to-be-recognized form image based on the at least one of the matching result of the form lines or the matching result of the form line intersections.

3. The method of claim 2, wherein performing the correction process on the to-be-recognized form image based on the at least one of the matching result of the form lines or the matching result of the form line intersections comprises:
obtaining a transformation parameter between the to-be-recognized form image and the preset form template based on the at least one of the matching result of the form lines or the matching result of the form line intersections, wherein the matching result of the form lines comprises the matching result of a plurality of form line pairs of the plurality of first form lines and the plurality of second form lines, and the matching result of the form line intersections comprises the matching result of a plurality of form line intersection pairs of the plurality of first form line intersections and the plurality of second form line intersections; and
performing the correction process on the to-be-recognized form image according to the transformation parameter.

4. The method of claim 3, wherein obtaining a transformation parameter between the to-be-recognized form image and the preset form template comprises at least one of:
obtaining the transformation parameter between the to-be-recognized form image and the preset form template based on at least one of matched form line pairs in the plurality of form line pairs or matched form line intersection pairs in the plurality of form line intersection pairs; or
obtaining the transformation parameter based on at least one of the form line pairs with a matching confidence level higher than a first preset value among the plurality of form line pairs, or the form line intersection pairs with a matching confidence level higher than a second preset value among the plurality of form line intersection pairs.

5. The method of claim 3, wherein obtaining a transformation parameter between the to-be-recognized form image and the preset form template comprises:
determining a target area based on the at least one of the matching result of the form lines or the matching result of the form line intersections, wherein the at least one of the matching result of the form lines or the form line intersections in the target area satisfies a preset condition; and
obtaining the transformation parameter between the to-be-recognized form image and the preset form template based on the at least one of the matching result of the form lines or the matching result of the form line intersections in the target area,
wherein at least one of a number of matching form line pairs in the target area or a number of matching form line intersection pairs in the target area satisfies a first condition, and
wherein at least one of a matching confidence level corresponding to matching form line pairs in the target area or a matching confidence level corresponding to matching form line intersection pairs in the target area satisfies a second condition.

6. The method of claim 3, wherein the preset form template comprises at least two template areas,
wherein obtaining a transformation parameter between the to-be-recognized form image and the preset form template comprises:
obtaining the transformation parameter corresponding to each of the at least two template areas based on the at least one of the matching result of the form lines or the matching result of the form line intersections, and
wherein performing a correction process on the to-be-recognized form image according to the transformation parameter comprises:
according to the transformation parameter corresponding to each of the at least two template areas, performing a respective correction process on an area of the to-be-recognized form image corresponding to each of the at least two template areas.

7. The method of claim 1, wherein performing a correction process on the to-be-recognized form image based on the form line extraction result of the to-be-recognized form image and a preset form template comprises:
in response to determining at least one of a first ratio of matching form line pairs in the plurality of first form lines reaching a first ratio value or a second ratio of matching form line intersection pairs in the plurality of first form line intersections reaching a second ratio value, performing the correction process on the to-be-recognized form image based on the form line extraction result of the to-be-recognized form image and the preset form template.

8. The method of claim 1, wherein performing a text recognition process on the corrected to-be-recognized form image to obtain a form recognition result comprises at least one of:
performing text detection on the corrected form image to obtain a plurality of text detection boxes of the to-be-recognized form image, performing text recognition on the plurality of text detection boxes to obtain a text recognition result, and obtaining the form recognition result based on an intersection-over-union ratio between the plurality of text detection boxes and a plurality of form boxes defined by the plurality of first form lines, or
determining at least one to-be-detected target form box from a plurality of form boxes defined by the plurality of first form lines in the to-be-recognized form image based on the preset form template, performing text recognition on the at least one target form box, to obtain a text recognition result of each target form box in the at least one target form box, and obtaining the form recognition result based on the text recognition result of the at least one target form box.

9. The method of claim 8, wherein determining at least one to-be-detected target form box from a plurality of form boxes defined by the plurality of first form lines in the to-be-recognized form image based on the preset form template comprises:
receiving a recognition condition entered by a user;
determining at least one target form box from a plurality of form boxes of the preset form template based on the recognition condition, and
wherein obtaining the form recognition result based on the text recognition result of the at least one target form box comprises:
obtaining the form recognition result based on the attribute of the target form box and the text recognition result of the target form box.

10. The method of claim 1, wherein obtaining a form line extraction result of a to-be-recognized form image by performing a form line extraction process on the to-be-recognized form image comprises:
determining a plurality of directional single-connected chains in the to-be-recognized form image;
performing a first merging process on at least two directional single-connected chains that satisfy a merging condition among the plurality of directional single-connected chains to obtain a plurality of first merged line segments;
performing an (i+1)-th merging process on at least two i-th merged line segments that satisfy the merging condition among a plurality of i-th merged line segments to obtain at least one (i+1)-th merged line segment; and
obtaining the form line extraction result of the to-be-recognized form image based on a merging result of N times of merging processes, wherein i and N are integers, and i is greater than 1 and less than N.

11. The method of claim 10, further comprising:
extending at least one end of each i-th merged line segment in the plurality of i-th merged line segments with at least one pixel to obtain a respective extended line segment of the i-th merged line segment;
determining the at least two i-th merged line segments that satisfy the merging condition from the plurality of i-th merged line segments based on the respective extended line segments of the plurality of i-th merged line segments.

12. The method of claim 10, wherein the merging condition comprises at least one of:
a minimum distance between end points of two to-be-merged objects being less than a first threshold,
a maximum distance between the end points of the two to-be-merged objects being less than a second threshold, or
a maximum distance from the end points of the two to-be-merged objects to a connection line corresponding to the maximum distance between the end points of the two to-be-merged objects that is less than the second threshold,
wherein the to-be-merged object is a directional single-connected chain or an i-th merged line segment.

13. A form recognition method performed by a computing device, the method comprising:
performing a form line extraction process on a reference form image to obtain a form line extraction result of the reference form image;
generating a form template based on the form line extraction result, wherein the form template comprises at least one of a plurality of form lines or a plurality of form line intersections; and
performing a text recognition process on a to-be-recognized form image to obtain the form recognition result based on the form template.

14. The method of claim 13, wherein generating a form template based on the form line extraction result comprises one of:
generating the form template based on the form line extraction result in response to a confirmation instruction from a user for the form line extraction result; or
performing an adjustment process on the form line extraction result to obtain an adjustment result in response to an adjustment instruction from a user, and generating the form template based on the adjustment result.

15. The method of claim 13, further comprising:
receiving a recognition instruction from a user, wherein the recognition instruction indicates a target form entry in the form template that is to be recognized, and
wherein performing a text recognition process on a to-be-recognized form image to obtain the form recognition result based on the form template comprises:
performing the text recognition process on the target form entry in the to-be-recognized form image based on the form template to obtain a form recognition result.

16. The method of claim 13, wherein performing a text recognition process on a to-be-recognized form image to obtain the form recognition result based on the form template comprises:
performing a corresponding form line extraction process on the to-be-recognized form image to obtain a corresponding form line extraction result of the to-be-recognized form image, wherein the corresponding form line extraction result comprises at least one of a plurality of first form lines or a plurality of first form line intersections;
obtaining a transformation parameter based on at least one of a plurality of second form lines or a plurality of second form line intersections included in the form template and the form corresponding line extraction result of the to-be-recognized form image; and
performing a text recognition process on the to-be-recognized form image to obtain a form recognition result according to the transformation parameter.

17. The method of claim 16, wherein obtaining a transformation parameter comprises:
performing at least one of a matching process on the plurality of first form lines and the plurality of second form lines to obtain a matching result of the form lines, or a matching process on the plurality of first form line intersections and the plurality of second form line intersections to obtain a matching result of the form line intersections, and
obtaining a transformation parameter between the to-be-recognized form image and the form template based on at least one of the matching result of the form lines or the matching result of the form line intersections, wherein the matching result of the form lines comprises the matching result of a plurality of form line pairs of the plurality of first form lines and the plurality of second form lines, and the matching result of the form line intersections comprises the matching result of a plurality of form line intersection pairs of the plurality of first form line intersections and the plurality of second form line intersections.

18. The method of claim 17, wherein obtaining a transformation parameter between the to-be-recognized form image and the form template based on the at least one of the matching result of the form lines or the matching result of the form line intersections comprises:
determining a target area based on the at least one of the matching result of the form lines or the matching result of the form line intersections, wherein the at least one of the matching result of the form lines or the form line intersections in the target area satisfies a preset condition; and
obtaining the transformation parameter between the to-be-recognized form image and the form template based on the at least one of the matching result of the form lines or the matching result of the form line intersections in the target area;
wherein the preset condition comprises at least one of:
at least one of a number of matching form line pairs or a number of matching form line intersection pairs in the target area satisfies a first condition, or
at least one of a matching confidence level corresponding to matching form line pairs in the target area or a matching confidence level corresponding to matching form line intersection pairs in the target area satisfies a second condition.

19. A device comprising:
at least one processor; and
at least one non-transitory machine readable storage medium coupled to the at least one processor having machine-executable instructions stored thereon that, when executed by the at least one processor, cause the at least one processor to perform operations comprising:
obtaining a form line extraction result of a to-be-recognized form image by performing a form line extraction process on the to-be-recognized form image, wherein the form line extraction result comprises at least one of a plurality of first form lines or a plurality of first form line intersections;
obtaining a corrected to-be-recognized form image by performing a correction process on the to-be-recognized form image based on the form line extraction result of the to-be-recognized form image and a preset form template, wherein the preset form template has at least one of a plurality of preset second form lines or a plurality of preset second form line intersections; and
performing a text recognition process on the corrected to-be-recognized form image to obtain a form recognition result.

20. The device of claim 19, wherein the operations further comprise:
performing a corresponding form line extraction process on a reference form image to obtain a corresponding form line extraction result of the reference form image;
generating the preset form template based on the corresponding form line extraction result.
